(19) United States
(12) Patent Application Publication
(10) Pub. No.: US 2023/0335162 A1
(43) Pub. Date: Oct. 19, 2023

(54) MAGNETIC RECORDING DISK WITH METALLIC LAYERS HAVING THICKNESSES CONFIGURED TO BALANCE WEIGHT AND RIGIDITY OF THE DISK

(71) Applicant: Western Digital Technologies, Inc., San Jose, CA (US)

(72) Inventors: Shoji Suzuki, San Jose, CA (US); Ling Huat Yap, Johor (MY); Ming Shian Liew, Sarawak (MY); Lih Shan Lim, Sarawak (MY)

(21) Appl. No.: 17/720,248

(22) Filed: Apr. 13, 2022

(51) Int. Cl. G11B 5/851; G11B 5/73

(52) U.S. Cl. CPC G11B 5/851; G11B 5/73919

(57) ABSTRACT

A disk for use in hard disk drives (HDD) or other magnetic recording apparatus is provided that includes a pair of plating layers, such as polished nickel-phosphorous (NiP) layers, on opposing sides of substrate, such as an aluminum-magnesium (Al—Mg) alloy substrate. The thicknesses of the two polished plating layers are set so that a ratio (by percentage) of the combined thickness of the polished layers is about 3% of the total thickness of the disk. The ratio of about 3% is employed based on a finding that this thickness ratio provides a beneficial tradeoff between disk rigidity and disk weight, particularly for use with polished NiP coatings on Al—Mg alloy substrates. Multi-platter stacks of the disks are described. Methods are also described for fabricating such disks.

### FIELD

The present disclosure relates to a magnetic recording disks and methods for fabricating such disks, and more particularly to magnetic recording disks having plating layers for use in a multi-platter hard disk drive (HDD) recording apparatus.

### INTRODUCTION

Magnetic storage devices such as hard drive disks (HDDs) are storage devices that store data or information magnetically. High-capacity HDDs often use multiple disks to store data (e.g., a multi-platter HDD). A multi-platter HDD may employ very thin disks. Within HDDs using such disks, disk deflections due to mechanical shocks to the HDD may exceed a gap between an outer edge of the disk and a load-unload ramp of the HDD, causing damage. As a practical matter, disk thickness cannot be easily increased since the size of the overall HDD needs to be meet certain specifications to fit within host devices or other housings or enclosures (e.g., a one-inch HDD chassis). In some disk designs, nickel-phosphorus (NiP) plating layers or other metallic layers are deposited on opposing sides of the disk substrate to improve disk rigidity. However, metallic plating adds weight and cost to the disk.

### SUMMARY

In one aspect, a method for fabricating a magnetic recording disk including a substrate and first and second metallic layers on opposing sides of the substrate is provided. The method includes: determining a combined thickness for the first and second metallic layers based on a predetermined ratio of the combined thickness of the metallic layers to a disk thickness of the disk; determining a first metallic layer thickness and a second metallic layer thickness based on the combined thickness; providing a substrate having a thickness selected so a thickness of the substrate and the first and second metallic layers will equal the disk thickness; forming the first metallic layer with the first metallic layer thickness on a first side of the substrate; forming the second metallic layer with the second metallic layer thickness on a second, opposing side of the substrate; and forming a magnetic recording layer on at least one of the metallic layers.

In another aspect, a magnetic recording disk is provided. The disk includes: a substrate; first and second metallic layers on opposing sides of the substrate, the first and second metallic layers having a combined thickness configured based on a predetermined ratio of the combined thickness to a disk thickness of the disk; and a magnetic recording layer on at least the first metallic layer.

In yet another aspect, an apparatus is provided for fabricating a disk for use in a magnetic recording apparatus. The apparatus includes: means for determining a combined thickness for first and second metallic layers, wherein the combined thickness is determined based on a predetermined ratio of the combined thickness of the metallic layers to a disk thickness; means for determining a first metallic layer thickness and a second metallic layer thickness based on the combined thickness; means for providing a substrate having a thickness selected so the thickness of the substrate and the first and second metallic layers will equal the disk thickness; means for depositing the first metallic layer with the first metallic layer thickness on a first side of the substrate; means for depositing the second metallic layer with the second metallic layer thickness on a second, opposing side of the substrate; and means for depositing a magnetic recording layer on at least one of the metallic layers.

### BRIEF DESCRIPTION OF THE DRAWINGS

FIG. 1 is a graph illustrating exemplary values for disk weight for various nickel-phosphorus (NiP) layer thicknesses on an aluminum-magnesium (Al—Mg) alloy substrate.

FIG. 2 is a graph illustrating exemplary values for relative dynamic rigidity of a disk for different NiP thicknesses.

FIG. 3 is a graph illustrating exemplary data for surface hardness of an NiP-plated substrate for different NiP thicknesses after polishing.

FIG. 4 illustrates a top plan view of a disk drive in accordance with an embodiment of the disclosure.

FIG. 5 illustrates a profile view of a slider and a disk in accordance with an embodiment of the disclosure.

FIG. 6 illustrates an exemplary disk having polished NiP layers with a combined thickness configured based on a predetermined ratio of combined thickness to the disk thickness for a 0.5 millimeter (mm) disk, in accordance with an aspect of the disclosure.

FIG. 7 illustrates an exemplary disk having NiP layers with a combined thickness configured based on the predetermined ratio of combined thickness to the disk thickness for a 0.4 mm disk, in accordance with another aspect of the disclosure.

FIG. 8 illustrates an exemplary magnetic recording medium having NiP layers with a combined thickness configured based on the predetermined ratio of combined thickness to the disk thickness, in accordance with another aspect of the disclosure.

FIG. 9 is a graph of exemplary data illustrating the percentage ratio of combined NiP layer thickness to disk thickness vs. disk thickness for various NiP layer thicknesses.

FIG. 10 illustrates a cross-sectional view of an exemplary multi-platter magnetic recording structure having a stack of disks on a spindle in accordance with an aspect of the disclosure, where each disk has NiP layers with a combined thickness configured based on a predetermined ratio of combined thickness to the disk thickness.

FIG. 11 illustrates an exemplary method for fabricating a magnetic recording disk having NiP layers on opposing sides of a substrate, where a combined thickness of the NiP layers is determined based on a predetermined ratio of combined thickness to the disk thickness, in accordance with aspects of the disclosure.

FIG. 12 illustrates an exemplary apparatus for fabricating a magnetic recording disk having NiP layers on opposing sides of a substrate, where a combined thickness of the NiP layers is determined based on a predetermined ratio of combined thickness to the disk thickness, in accordance with aspects of the disclosure.

FIG. 13 illustrates an exemplary magnetic recording disk having plating layers with a combined thickness configured based on the predetermined ratio of combined thickness to the disk thickness, in accordance with another aspect of the disclosure.

FIG. 14 illustrates an exemplary method for fabricating a magnetic recording disk having plating layers with a combined thickness configured based on the predetermined ratio of combined thickness to the disk thickness, in accordance with another aspect of the disclosure.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

Disk rigidity and disk weight are important properties of a magnetic recording disk for use in a hard disk drive (HDD). Sufficient disk rigidity helps ensure that the disk does not vibrate too much during operation (e.g., while spinning). The higher the disk rigidity, the lower the disk vibration. Disk rigidity may be improved by coating or plating opposing sides of an aluminum-magnesium (Al—Mg) disk substrate with nickel-phosphorous (NiP) or other suitable metallic coatings. NiP improves disk rigidity because NiP has a much higher Young's modulus (e.g., 200 gigaPascals (GPa)) as compared to the Young's modulus of the Al—Mg substrate (e.g., 68 GPa). However, NiP is relatively heavy, thus increasing disk weight, which can increase an amount of deformation in the base (chassis) of the drive, which in turn can exacerbate problems with vibration. Moreover, NiP takes considerable time to deposit, thus increasing disk fabrication costs. Thus, in some aspects, it is desirable that HDD disks have sufficient rigidity without weighing too much or costing too much. This becomes particularly challenging in multi-platter disk drives.

A multi-platter HDD may require disks with a thickness of 0.5 millimeters (mm) to accommodate a 10D form factor (e.g., ten disks within a one-inch chassis) and even thinner disks for 11D or 12D form factors. One challenging problem is to reduce disk deflections of thin disks that occur when mechanical shock forces act on the drive such as, e.g., during a hot swap that can trigger an “Op-shock.” With a hot swap, some drives within a server chassis are operating while one drive is replaced. As such, any bumping of the server during the hot swap can impart shocks to the drives that are spinning. For large HDDs, especially those used in server racks in data centers, a significant Op-shock problem to be avoided is contact between a disk and ramp (which can occur with a shock of less than 30 G). In this regard, while an HDD is in operation mode, the spindle may be rotating at a high speed such as 7200 RPM. If the outer diameter (OD) edge of the disk(s) deflect enough to close the gap between the edge and the bottom surface of the Load/Unload ramp, the moving edges rub the plastic part of the ramp. This can generate wear, e.g., cause debris, and those small particles can migrate to the data surfaces. Once such particles are trapped by the slider or magnetic Read/Write (R/W) elements, they disturb the proper spacing generated by the air-bearings or R/W functions. R/W elements can be mechanically damaged also. In this regard, during read/write, the spacing between the slider and the disk may be only 1 nanometer (nm) instead of 10 nm, and hence a slight bump can cause damage.

Note that thicker disks can have greater rigidity than thinner disks, but thicker disks are often not feasible given the form factor constraints, and so thin disks (e.g., disks with thickness ≤0.5 mm) may be needed. Because of the form factor constraints, there is not much room available within an HDD to reduce the risk of damage from disk deflections. Note also that, although thinner NiP reduces the surface hardness (and hence leaves the disk potentially prone to damage), an Op-shock level less than 30 G is usually small enough for a slider/head to avoid head-slaps, and hence avoid such damage. Therefore, NiP thickness can be reduced without impacting the reliability of the drives.

Moreover, the spacing budget for head/suspensions, load/unload ramp clearance, vibration (outer diameter edge deflection), and other constraints affect the choice of disk thickness. For a platter with nine or more disks, prevention of disk-to-ramp contacts under Op-shock G-shocks becomes a critical factor to determine the optimal disk thickness. The risk of disk-to-ramp contacts depends largely OD disk edge deflection. Generally speaking, OD disk edge deflection is determined by two factors: disk rigidity and drive base (chassis) deformation. Base deformation increases as the weight of a disk-spacer stack increases. Therefore, reducing the disk weight can help reduce the base deformation.

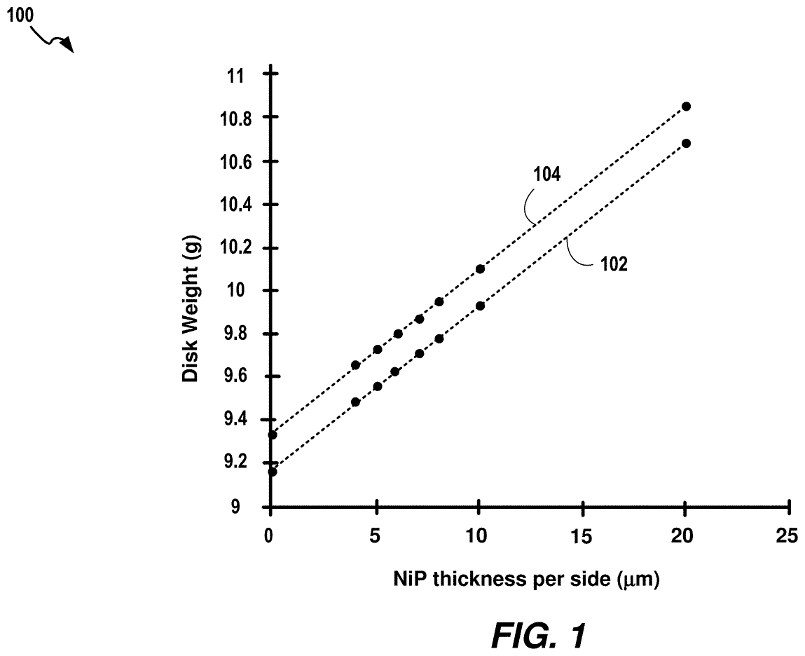

FIG. 1 is a graph 100 illustrating exemplary values for disk weight (Y-axis) for a 0.5 mm disk for various NiP layer thicknesses (X-axis) on an Al—Mg alloy substrate. The disk has an OD of 97 mm and an inner diameter (ID) of 25 mm. Data is shown for two different Al—Mg alloy densities: 2.65±0.02 grams/centimeter³ (g/cm³) and 2.75±0.05 g/cm³. More specifically, a first line 102 illustrates data for 2.65±0.02 g/cm³. A second line illustrates data for 2.75±0.05 g/cm³. These are typical densities for commercially available Al—Mg alloys. As shown in the figure, disk weight increases significantly with increasing NiP thickness. Note that the NiP thickness shown in the figure is the thickness of the NiP coating on one side of the substrate. The disk has NiP coatings of equal thickness on both sides of the substrate. When designing a disk, the thickness of the ground substrate (e.g., the Al—Mg alloy substrate) and the thickness of the NiP layers coated onto the opposing sides of the substrate are selected to meet a target thickness (such as 0.500 mm). Although thinner NiP coatings are desirable to reduce the base deformation (by reducing disk weight), rigidity issues can arise in thin disks.

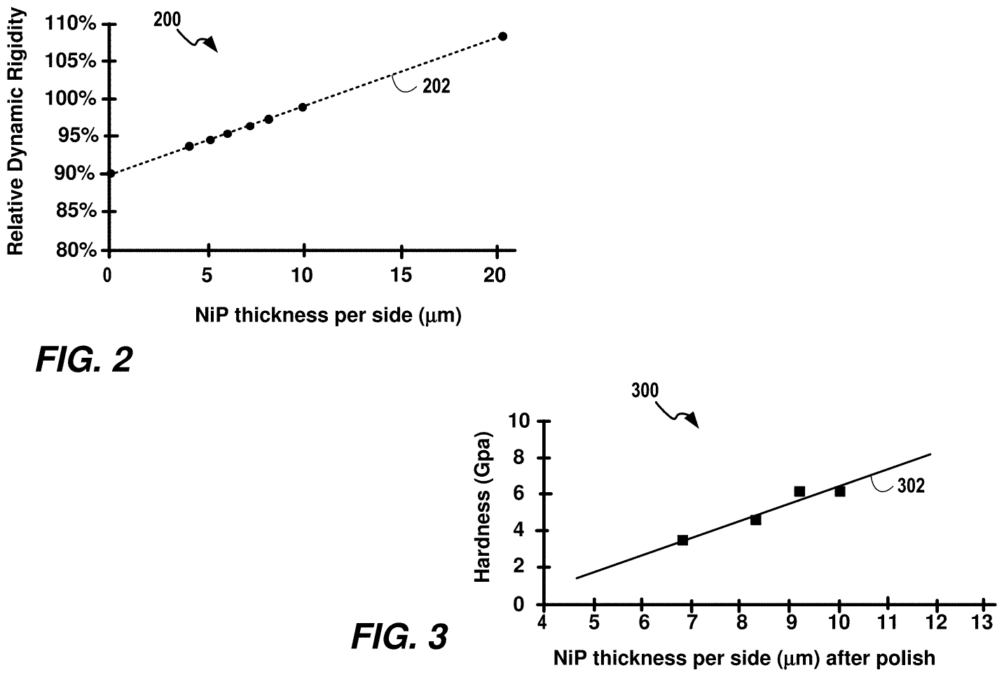

FIG. 2 is a graph 200 illustrating exemplary values for the relative dynamic rigidity of a disk (Y-axis) for a 0.5 mm disk for different NiP thicknesses (X-axis), with the rigidity of a 10 micron (μm) NiP layer providing a rigidity baseline of 100%. The disk again has an OD of 97 mm and an ID of 25 mm. As shown by way of line 202, rigidity decreases for thinner NiP layers and increases for thicker NiP layers. As a practical matter, a reduction in rigidity from the baseline of 100% down to 95% is generally acceptable in HDDs. Therefore, based on the data in FIG. 2, an NiP thickness of 4 μm may be a lower limit in at least some drives.

FIG. 3 is a graph 300 illustrating exemplary data for surface hardness (Y-axis) in GPa (as measured by Knoop indentation) of an NiP-plated substrate for different NiP thicknesses after polishing (X-axis). NiP is a much harder material than Al—Mg, and so the NiP plating makes the disk surface harder than Al—Mg by itself. As shown by line 302, the hardness increases within increasing NiP thickness. Under this test condition (Knoop indentation), a 4 μm thickness still has sufficient hardness (2 GPa) to prevent mechanical damage to the disk (e.g., disk-to-ramp impact). However, an NiP layer thickness less than 4 μm or 5 μm might lack sufficient hardness to prevent mechanical damage, and hence a NiP layer thickness of 4 μm may be viewed as a lower limit (for at least some 10D HDD applications).

In light of these considerations, it is desirable to identify an optimal (or preferred or target) NiP thickness for use with different substrate thicknesses to provide sufficient dynamic disk rigidity with sufficient hardness and yet without adding too much weight.

Herein, disks for use in HDDs or other magnetic recording apparatus are described wherein the disks are configured based on a finding that an optimal ratio (R) of the combined thickness (T) of two polished NiP layers to the thickness of the disk (D) is about 3%±0.5%, and more generally in the range of 2% to 4%. For example, for a 0.5 mm disk, the thickness of each of the polished NiP layers should be 7 μm±1 μm (or 14μm±2 μm for both NiP coatings). For a 0.4 mm disk, the thickness of each of the polished NiP layers should be 6 μm±1 μm (or 12 μm±2 μm for both NiP coatings). As noted above, issues can arise if the thickness of an individual NiP layer becomes too small, e.g., less than 4 μm, and so for any disks that might be so thin that the aforementioned ratio formula would yield a NiP thickness below 4 μm, 4 μm is instead preferably used. Although described primarily using examples where the metallic layers are NiP, aspects of the present disclosure are applicable to other suitable layers or coatings as well.

### Exemplary Disk Drive with Magnetic Recording Media

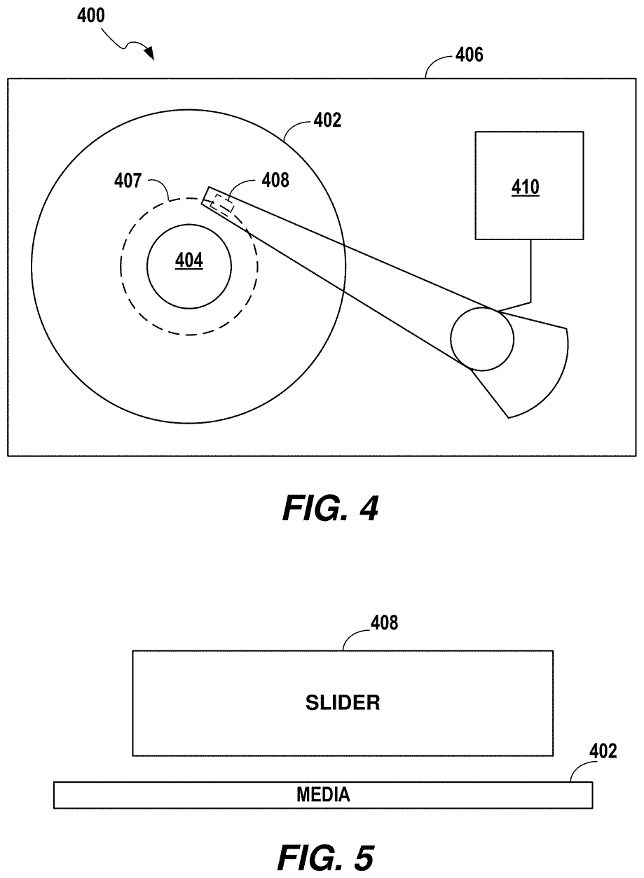

FIG. 4 is a top schematic view of a disk drive 400 configured for magnetic recording and including a magnetic recording medium 402 having disks where a ratio R of combined plating thickness to disk thickness is about 3%±0.5%, in accordance aspects of the disclosure. In illustrative examples, the magnetic recording medium 402 includes a perpendicular magnetic recording (PMR) medium. However, other recording media, such shingle-written magnetic recording (SMR) media, heat assisted magnetic recording (HAMR) or microwave assisted magnetic recording (MAMR) media may be used in other examples. Disk drive 400 may include one or more disks/media 402 to store data. Disk/media 402 resides on a spindle assembly 404 that is mounted to drive housing 406. Data may be stored along tracks 407 in the magnetic recording layer of disk 402. The reading and writing of data is accomplished with the head/slider 408 that may have both read and write elements. The write element is used to alter the properties of the magnetic recording layer of disk 402 and thereby write information thereto. In one embodiment, recording head 408 may have magneto-resistive (MR), or giant magneto-resistive (GMR) elements, such as tunnel magneto-resistive (TMR) elements for reading, and a write pole with coils that can be energized for writing. In another embodiment, head 408 may be another type of head, for example, an inductive read/write head or a Hall effect head. In operation, a spindle motor (not shown) rotates the spindle assembly 404, and thereby rotates disk 402 to position head 408 at a particular location along a desired disk track 407. The position of the head 408 relative to the disk 402 may be controlled by position control circuitry 410.

FIG. 5 is a side cross sectional schematic view of selected components of the magnetic recording system of FIG. 4 including the magnetic recording medium 402 with disks configured in accordance with aspects of the disclosure. The head/slider 408 is positioned above the medium 402. The head/slider 408 includes a write element and a read element (not shown) positioned along an air bearing surface (ABS) of the slider (e.g., bottom surface) for writing information to, and reading information from, respectively, the medium 402. FIGS. 4 and 2 illustrate a specific example of a magnetic recording system. In other examples, embodiments of the improved media can be used in other suitable magnetic recording systems (e.g., such as SMR, HAMR, and MAMR recording systems). For simplicity of description the various embodiments are primarily described in the context of an exemplary HDD magnetic recording system.

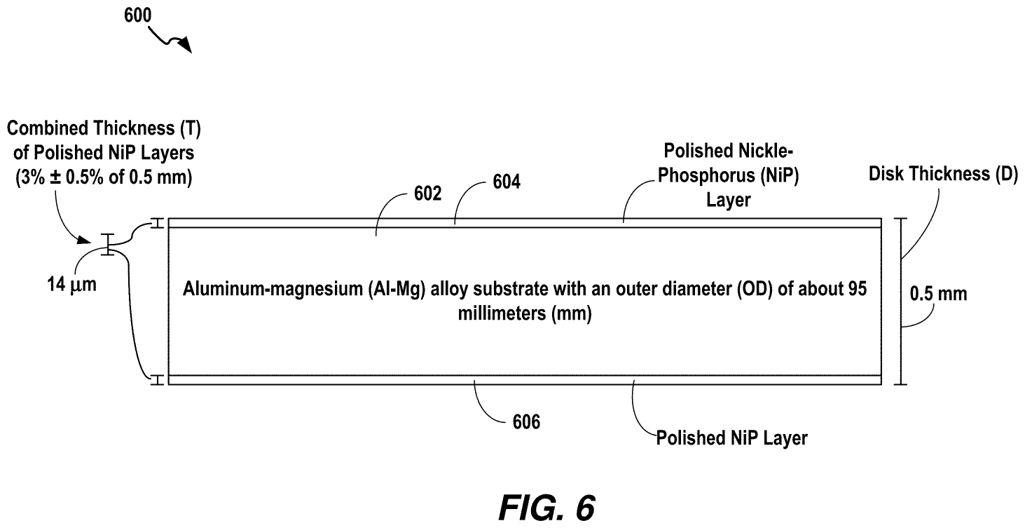

FIG. 6 illustrates, in simplified form, an exemplary magnetic recording medium, platform or structure in the form of a disk 600 having a substrate 602 formed of Al—Mg alloy having a density of 2.65 g/cm³ and a Young's modulus of about 68 GPa. A first polished NiP coating or layer 604 with a Young's modulus of 200 GPa is formed on a first (e.g., top) side surface of the substrate 602. A second polished NiP coating or layer 606 (also with a Young's modulus of 200 GPa) is formed on a second (e.g., bottom) side surface of the substrate 602. Although not shown in FIG. 6, additional layers, such as magnetic recording layers, may be formed on the NiP layers 604 and 606. Note that the NiP thickness of the main examples described herein is a final polished thickness, which can be measured on the finished media, e.g., a disk removed from a working drive. After NiP plating, disks may be subjected to a polishing process (e.g., typically a two-step polish). The polishing removes some amount of NiP, typically a few μm from each side. The removal can be controlled accurately on the order of less than 1 micron. However, the side-to-side thickness variation can be. e.g., 0.1 to 0.4 μm.

In the example of FIG. 6, the disk 600 is 0.5 mm thick (D) and the two polished NiP layers 604 and 606 are each 7 μm thick (½T), for a combined NiP layer thickness (T) of 14 μm. The substrate 602 is 0.486 mm. The combined NiP layer thickness (T) of the polished NiP layers in this example is 2.8% of the 0.5 mm thickness (D) of the disk 600. In other words, the ratio R (by percentage) of the combined NiP layer thickness to the disk thickness is in the range of 3%±0.5%. As explained above, this is a target thickness ratio R, which is intended to provide an optimal balance of disk rigidity to disk weight. Although a ratio R in the range of 3%±0.5% is used in this example, the ratio R may be more generally in the range of 2% to 4%. In some examples the thickness of each of the polished NiP layers may be, for example, 7 μm±1 μm (or 14 μm±2 μm for both NiP coatings). The target ratio R may further depend on the density of the Al—Mg alloy of the substrate. For example, for a density of 2.75±0.05 g/cm³ (e.g., 2.70 to 2.8 g/cm³, inclusive), polished NiP thickness may be reduced by 2 μm per side to compensate the increased weight of the substrate.

Note that in practice it can be difficult to achieve a precise NiP thickness during deposition and polishing of an NiP layer and so the thickness of the two NiP layers might differ slightly. Small differences in the thicknesses of the two NiP layers are not a problem so long as the disk meets any specified flatness requirements for the HDD. (A significant difference in the thicknesses of two opposing NiP layers can lead to warping of the disk.) As such, a thickness of ½T should be viewed as a target thickness for each of the two NiP layers with T being the target thickness for the two layers combined.

Magnetic recording layers or other layers deposited on the NiP layers (not shown in FIG. 6) are typically very thin (e.g., collectively 100-200 angstroms (Å) thick) and therefore do not significantly affect the overall disk thickness. Nevertheless, if warranted, the additional thickness provided by those layers may be compensated for by providing a slightly thinner substrate, so that the overall disk thickness is 0.5 mm for use in an HDD that accommodates 0.5 mm disks. Note also that FIG. 6 and other the figures herein are not to scale.

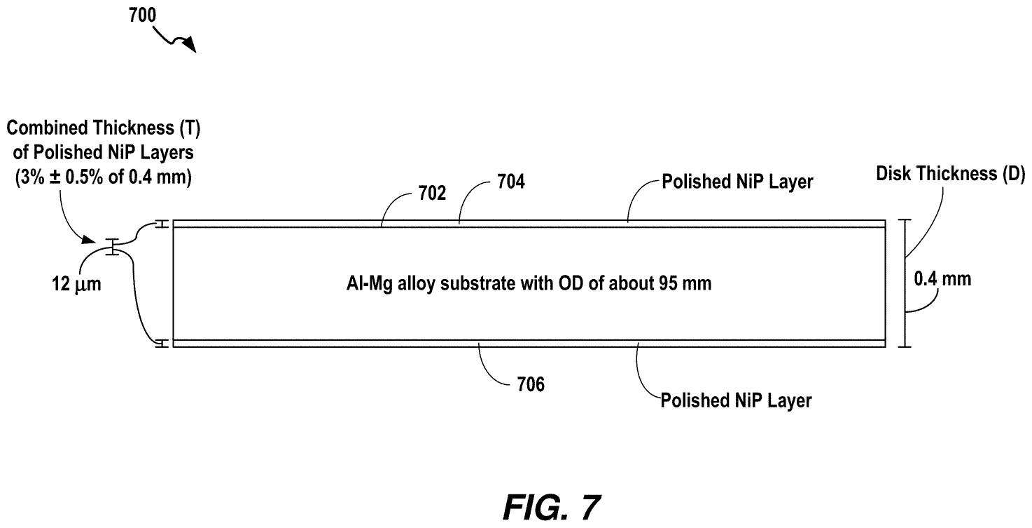

FIG. 7 illustrates another exemplary magnetic recording medium, platform or structure in the form of a disk 700 having a substrate 702 formed of Al—Mg alloy with a density of 2.65 g/cm³ and a Young's modulus of about 68 GPa. A first polished NiP coating or layer 704 with a Young's modulus of 200 GPa is formed on a top surface of the substrate 702. A second polished NiP coating or layer 706 with a Young's modulus of 200 GPa is formed on a bottom surface of the substrate 702. Although not shown in FIG. 7, additional layers, such as magnetic recording layers, may be formed on the NiP layers 704 and 706.

In the illustrative example of FIG. 7, the disk 700 is 0.4 mm thick, the two polished NiP layers 704 and 706 are each 6 μm thick, for a combined NiP layer thickness T of 12 μm. The substrate 702 is 0.388 mm. As such, the combined NiP layer thickness T of the polished NiP layers is 3.0% of the 0.4 mm thickness of the disk 700. That is, the ratio R (by percentage) of the combined polished NiP layer thickness to the disk thickness is 3%. Although a ratio R of about 3% is used in this example, the ratio R may be in the broader ranges noted above. As such, in some examples the thickness of each of the polished NiP layers of FIG. 7 may be, for example, 6 μm±1 μm (or 12 μm±2 μm for both NiP coatings). As already explained, the target ratio R may further depend on the density of the Al—Mg alloy of the substrate, and the polished NiP thickness may be reduced to compensate the increased weight of the substrate (though, preferably, not reduced below 4 μm).

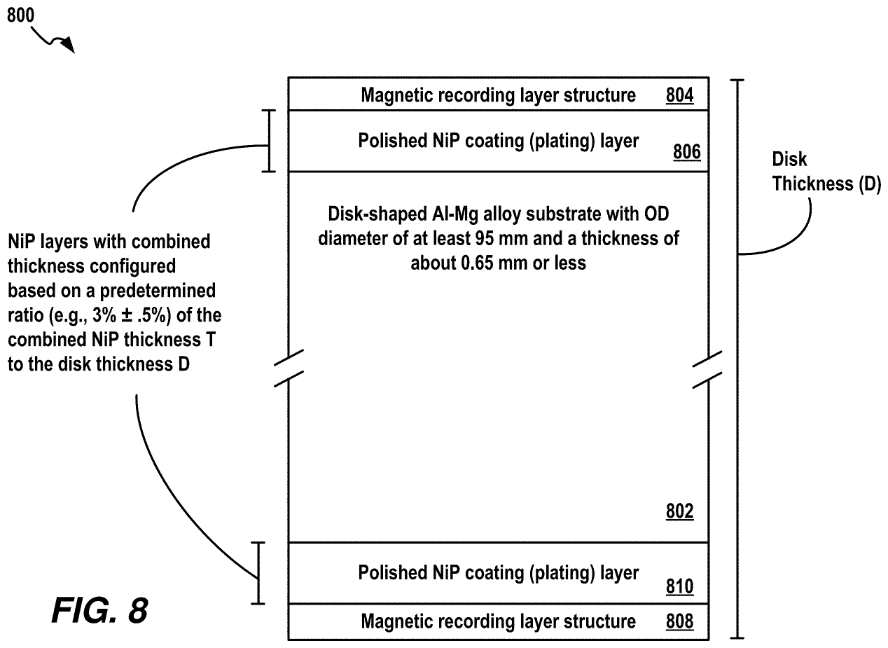

FIG. 8 illustrates, in simplified form, another exemplary magnetic recording medium, platform or structure in the form of a disk 800 having a disk-shaped Al—Mg alloy substrate 802 with OD diameter of at least 95 mm and a thickness of about 0.65 mm or less. In some examples, the disk 800 has an OD of about 97 mm. In other examples, the OD may be 98 mm or 98.1 mm. (Generally speaking, such disks are all referred to as “3.5 inch” disks.) In some implementations, the disk 800 may have a thickness in a range of 0.2 mm to 0.5 mm (e.g., 0.2 mm, 0.38 mm, or 0.5 mm). In some implementations the disk thickness is larger, such as in the range of 0.5 mm to 0.65 mm. The Young's modulus (E) value for a substrate may be, e.g., in a range of 60-100 gigapascals (GPa) (e.g., 68 GPa, 95 GPa, or 60-80 GPa). Generally speaking, the rigidity of a disk depends on its thickness, the Young's modulus of the substrate material, the disk diameter, and other factors such as the media fabrication processes.

A first magnetic recording layer structure 804 is deposited on one side (e.g., the top side) of the substrate 802 above the intervening polished NiP coating (plating) layer 806. A second magnetic recording layer structure 808 is deposited on the other side (e.g., the bottom side) of the substrate 802 below the other intervening polished NiP coating (plating) layer 810. In addition to providing rigidity to the disk, the NiP coatings also allow for easier polishing (since an Al—Mg alloy substrate is not easy to polish). The NiP coatings are amorphous and provide a smoother layer to allow for deposition of a magnetic recording layer structure. The NiP layers also help prevent corrosion. As noted above, an NiP coating is also a very hard layer, which is beneficial. A combined thickness T of the polished NiP layers 806 and 810 is configured based on a predetermined ratio R (e.g., 3%±0.5%) of the combined NiP thickness to the disk thickness. As noted above, if the predetermined ratio R provides for a polished NiP layer that is thinner than 5 μm, 5 μm may be used instead so that the NiP layer is not too thin.

In FIG. 8, the disk thickness is shown as including the magnetic recording layer structures 804 and 808. As already explained, such magnetic recording layers or structures are very thin compared to the NiP layers and the substrate and hence do no add much to the total thickness (D) of the disk. That is, the disk thickness D is almost entirely made up of the NiP layers and the substrate (with the substrate providing about 97% of that thickness).

The first and second magnetic recording layers (e.g., 804, 808) may include, e.g., cobalt-platinum (CoPt), iron-platinum (FePt) alloy, and/or combinations thereof. Although not shown in FIG. 8, the magnetic recording layer structure 804 may include magnetic recording sub-layers and exchange control sub-layers (ECLs). Collectively, the sub-layers form a magnetic recording layer structure 804 that may be, e.g., 100-200 Å thick. Note that other coatings may be provided as well, which are also very thin and do not significantly add thickness. For example, protective layers may be deposited that include carbon, diamond-like crystal, carbon with hydrogen and/or nitrogen doping, and/or combinations thereof. Thus, for clarity and simplicity, FIG. 8 only shows some of the layers typically included in a recording medium. Other figures herein similarly present simplified views with other layers omitted.

Illustrative details of exemplary HAMR disk layers are set forth in U.S. patent application Ser. No. 17/488,703, entitled “MAGNETIC RECORDING MEDIA WITH TUNGSTEN PRE-SEED LAYER,” filed Sep. 29, 2021 (Atty. Docket WDT-1384 (WDA-5747-US)), which is assigned to the assignee of the present application and fully incorporated by reference herein. Illustrative details of exemplary PMR disk layers are set forth in U.S. patent application Ser. No. 17/193,920, entitled “HIGH TEMPERATURE LUBRICANTS FOR MAGNETIC MEDIA,” filed Mar. 5, 2021 (Atty. Docket WDT-1368 (WDA-5286-US)), which is assigned to the assignee of the present application and fully incorporated by reference herein.

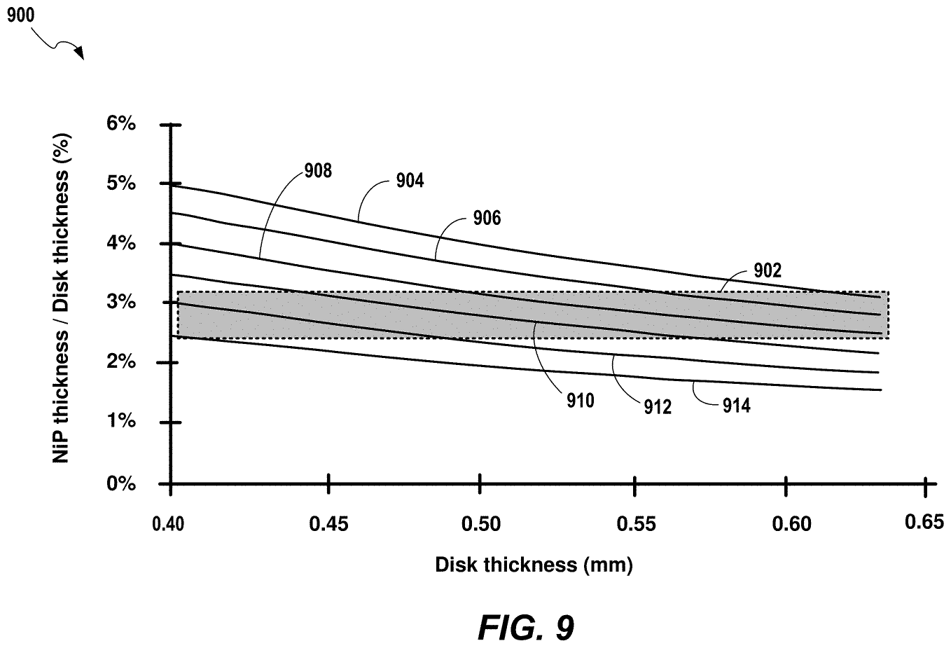

FIG. 9 is a graph 900 of exemplary data illustrating the percentage ratio R (Y-axis) of the combined NiP layer thickness T to disk thickness D vs. the disk thickness D in mm (X-axis) for various NiP layer thicknesses from 0.4 mm to nearly 0.65 mm. The figure also illustrates a preferred range of ratios R 904, which in this particular example extends from 2.5% to 3.2%. This is a range of values in which the resulting disk should have adequate rigidity without excessive weight.

A first curve 904 illustrates the ratio R for NiP layers that are each 10 μm thick (i.e., the combined NiP layer thickness T of the top and bottom NiP layers is 20 μm). As shown, for a 0.4 mm disk thickness, the resulting ratio R is about 5% (i.e., 20 μm/0.4 mm*100). For a 0.5 mm disk thickness, the ratio R is about 4% (i.e., 20 μm/0.5 mm*100). The 10 μm NiP curve 904 does not overlap the preferred ratio R range 902 until the disk thickness D is nearly 0.65 mm. An NiP layer thickness of 10 μm (with a combined NiP layer thickness T of 20 μm) is thus outside the preferred range 902 for all disk thicknesses below 0.6 mm, and hence 10 μm is not considered a good thickness for the NiP layers for thinner disks (<0.6 mm).

A second curve 906 illustrates the ratio R for NiP layers that are each 9 μm thick (i.e., the combined NiP layer thickness T of the top and bottom NiP layers is 18 μm). As shown, for a 0.4 mm disk thickness, the resulting ratio R is about 4.5%. For a 0.5 mm disk thickness, the ratio R is about 3.6%. The 9 μm NiP curve 906 does not overlap the preferred ratio R range 902 until the disk thickness D is above 0.55 mm. An NiP layer thickness of 9 μm (combined NiP layer thickness: 18 μm) is thus outside the preferred range 902 for disk thicknesses below 0.55 mm, and hence is not considered a good thickness for the NiP layers for thinner disks (<0.55 mm).

A third curve 908 illustrates the ratio R for NiP layers that are each 8 μm thick (i.e., the combined NiP layer T thickness is 16 μm). As shown, for a 0.4 mm disk thickness D, the resulting ratio R is about 4.%. For a 0.5 mm disk thickness, the ratio R is about 3.2%, which is the point at which the curve 908 begins to overlap the preferred ratio R range 902. An NiP layer thickness of 8 μm (combined NiP layer thickness: 16 μm) is thus deemed acceptable for disk thicknesses of 0.5 mm and above but is outside the preferred range 902 for disk thicknesses below 0.5 mm. For a disk thickness of about 0.55 mm, the ratio R (2.9%) is in the middle of the preferred range and hence 8 μm is a good thickness choice for 0.55 mm disks.

A fourth curve 910 illustrates the ratio R for NiP layers that are each 7 μm thick (i.e., the combined NiP layer T thickness is 14 μm). As shown, for a 0.4 mm disk thickness, the resulting ratio R is about 3.5%. For a 0.5 mm disk thickness, the ratio R is about 2.8%, which is near the middle of the preferred ratio R range 902. An NiP layer thickness of 7 μm (combined NiP layer thickness: 14 μm) is thus a particularly good thickness choice for 0.5 mm disks.

A fifth curve 912 illustrates the ratio R for NiP layers that are each 6 μm thick (i.e., the combined NiP layer thickness T is 12 μm). As shown, for a 0.4 mm disk thickness, the resulting ratio R is 3%. An NiP layer thickness of 6 μm (combined NiP layer thickness: 12 μm) is thus a particularly good thickness choice for 0.4 mm disks. For a 0.5 mm disk thickness, the ratio R is 2.4%, which is below the preferred ratio range 902.

A sixth curve 914 illustrates the ratio R for NiP layers that are each 5 μm thick (i.e., the combined NiP layer thickness T is 10 μm). As shown, for a 0.4 mm disk thickness, the resulting ratio is 2.5%, which is at the bottom of the preferred ratio range 902. As such, an NiP layer thickness of 5 μm (combined NiP layer thickness: 10 μm) is considered acceptable for 0.4 mm disks but not regarded as optimal.

FIG. 9 thus illustrates various acceptable, preferred or target NiP coating thicknesses for various disk thicknesses for an example where the acceptable range of ratios R extends from 2.5% to 3.2%. For a wider range of acceptable ratio R values (e.g., 3% to 4%), a wider range of NiP thickness would be deemed acceptable. For a narrower range of acceptable ratio values (e.g., 2.8% to 3.2%), a narrower range of NiP thickness would be deemed acceptable. The choice of the range of acceptable ratio values may be made by HDD designers based on the particular tradeoffs needed in a particular HDD design to balance disk rigidity with disk weight and other factors. The illustrative data in FIG. 9 was obtained for an Al—Mg alloy with 2.65 g/cm³, a Young's modulus of about 68 GPa, and an OD of 97 mm. The range of acceptable ratio values may be adjusted for other alloy densities having different Young's modulus values. It is noted that disk deflection and other parameters are relatively uniform above 95 mm.

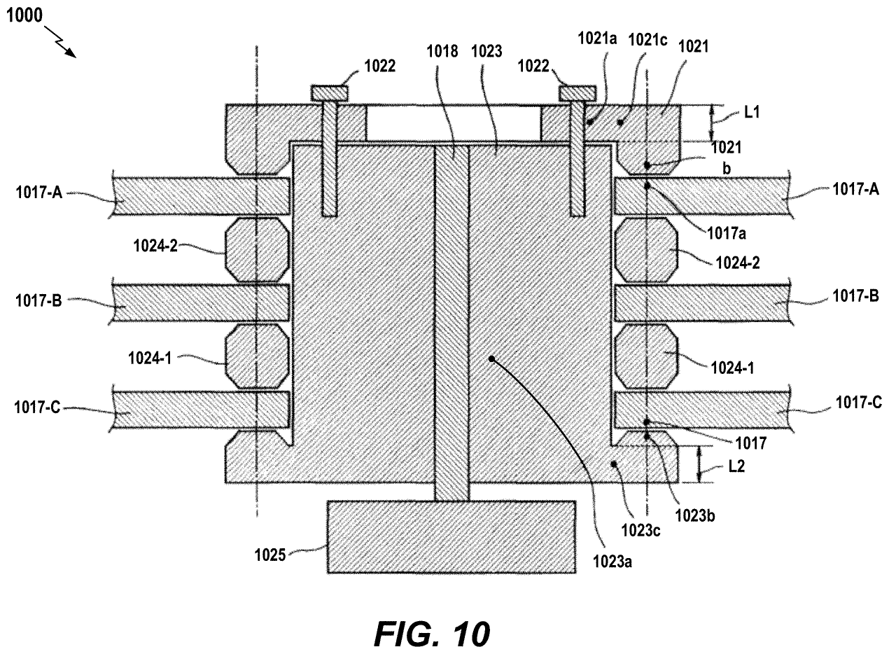

FIG. 10 is a cross-sectional view showing sub-components of a data storage device 1000 including multiple recording disks (e.g., each including a substrate with a thickness of no more than 0.5 millimeters (mm) and NiP plating layers on opposing sides of the substrate with a combined thickness configured or selected based on a predetermined ratio R (e.g., 3%) of the combined thickness to the disk thickness in accordance with an aspect of the present disclosure. In this example, the media (recording disks) include three recording disks 1017-A, 1017-B, and 1017-C, collectively referred to as recording disks 1017, with magnetic recording layers provided adjacent their respective top and bottom surfaces. In other examples, ten or more of the disks may be in a stacked configuration, as explained above.

The recording disks 1017 are stacked and secured to a hub 1023, which is coupled to a spindle shaft 1018. In an aspect, the top and bottom surfaces of each disk of the recording disks 1017 may individually be used as information recording surfaces, and an individual magnetic head on a slider (e.g., slider 108 in FIGS. 1 and 2) is used for each surface. Moreover, each recording disk 1017 may include a NiP plating layer, as discussed above, as well as a recording layer structure. Individual disks are rotated together with the hub 1023 and spindle shaft 1018, which may be rotated by a spindle motor 1025. In the following descriptions, for ease of explanation, the spindle motor 1025 is described as a rotational shaft type that rotates the spindle shaft 1018 according to some aspects, however, a stationary shaft type that does not rotate the spindle shaft 1018 may also be used in other aspects.

The hub 1023 may have a cylindrical shape/portion 1023a. The recording disks 1017 may each have a central hole or central opening configured to fit on the cylindrical portion 1023a of the hub 1023. The hub 1023 also includes a perimetric portion 1023b and a connecting portion 1023c that extends outwardly from the cylindrical portion 1023a. The perimetric portion 1023b supports the lowermost recording disk 1017-C. A first ring-shaped spacer 1024-1 is disposed on top of recording disk 1017-C. Recording disk 1017-B is on top of first ring-shaped spacer 1024-1, and a second-ring shaped spacer 1024-2 is disposed on top of recording disk 1017-B. Recording disk 1017-A is on top of second-ring shaped spacer 1024-2. In FIG. 10, the assembly 1000 includes three recording disks 1017 and two spacers. In other aspects, the assembly 1000 (e.g., data storage device) may have more than or less than three recording disks, and more than or less than two spacers, for example, ten disks with nine spacers. With this arrangement, at least one spacer is disposed between each adjacent pair of the disks of the plurality of stacked disks.

The recording disks 1017 may be secured to the hub 1023 by a top clamp 1021 placed at the top of the hub 1023, and therefore, may secure recording disk 1017-A, with a downward force opposing the upward force/support provided by the perimetric portion 1023b of the hub 1023, from an upper portion of the data storage device 1000. The top clamp 1021 and the hub 1023 may be secured together using one or more screws 1022, each providing a torque of 40 centinewton meter (cNm), which may also secure the recording disks 1017 to the spindle shaft 1018. For example, if six screws 1022 are used, then the screws 1022 may be disposed at intervals of 60 degrees, dividing the angle of 360° degrees of the circumference of a recording disk 1017 into six parts.

In some aspects, the hub 1023 may be made of stainless steel. However, the hub 1023 may also be made of aluminum or an aluminum alloy according to some other aspects. In an aspect, the top clamp 1021 may be made of stainless steel, for example. The clamping force may be obtained from a tightening force used to tighten the screws 1022 that presses on a clamp portion 1017a of disk 1017-A and a clamp portion 1017b of disk 1017-C, in part from the perimetric portion 1023b, and thereby secure the disks 1017 to the hub 1023 at upper and lower portions of the data storage device. (The screws thus provide a clamping mechanism.) The hub 1023 is secured to the spindle shaft 1018, which is the axis of rotation of the spindle motor 1025. The top clamp 1021 is secured by tightening the screws 1022 into the hub 1023. As shown in FIG. 10 and described above, the ring-shaped spacers 1024-1 and 1024-2, collectively referred to as 1024, (e.g., made of a ceramic material, composite material, polymer, and/or metal alloy) are inserted in the spaces among the three recording disks 1017-A, 1017-B, and 1017-C.

A radius of the cylindrical portion 1023a of the hub 1023 that passes through center holes of the recording disks 1017-A, 1017-B, and 1017-C may be smaller than a radius of a perimetric portion 1023b which holds the recording disk 1017-C from the lower portion of the data storage device 1000. Likewise, a radius at which screwing positions 1021a are disposed in the top clamp 1021 may be smaller than a radius of a perimetric portion 1021b which holds the recording disk 1017-A from the upper portion of the data storage device 1000. The screwing positions 1021a and the perimetric portion 1021b of the top clamp 1021 may be integrally formed in a stainless-steel member (e.g., top clamp 1021), and the thickness of a connecting portion 1021c may be L1. The cylindrical portion 1023a and the perimetric portion 1023b of the hub 1023 may also be integrally formed in a stainless-steel member, and the thickness of a connecting portion 1023c may be L2.

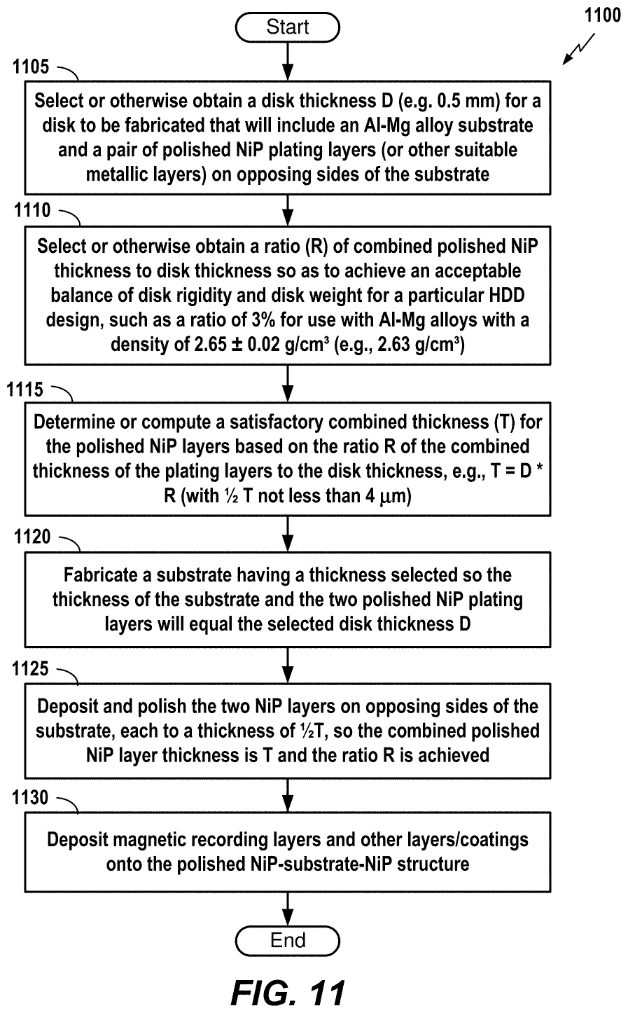

FIG. 11 illustrates a method 1100 for fabricating a magnetic recording disk having NiP layers on opposing sides of a substrate. At block 1105, a fabrication system or apparatus selects (or is programmed for use with or otherwise obtains) a disk thickness D (e.g., 0.5 mm) for a disk to be fabricated that will include an Al—Mg alloy substrate and a pair of polished NiP plating layers on opposing sides of the substrate or other suitable metallic layers. Hence, in some examples, the apparatus obtains a selection of disk thickness (e.g., 0.5 mm) by receiving that selection as input into the apparatus from an operator or user of the system. In other examples, the apparatus selects the thickness itself, e.g., by selecting from a list of permissible disk thicknesses in a database.

At block 1110, the apparatus selects (or is programmed for use with) a desired ratio R of combined polished NiP thickness to disk thickness D so as to achieve an acceptable balance or trade-off of disk rigidity and disk weight for a particular HDD design, such as a ratio of 3% for use with Al—Mg alloys having a density of 2.65±0.02 g/cm³ (i.e., a density of 2.63 to 2.67 g/cm³, inclusive). In some examples, the apparatus obtains a selection of the ratio R by receiving that selection as input into the apparatus from an operator or user of the system. In other examples, the apparatus reads the ratio from its database. In one example, the apparatus is simply programmed to use a ratio R of 3% since, for most HDDs using 0.5 mm disks, that ratio value will provide a good tradeoff between rigidity and weight for the reasons explained above, at least for Al—Mg alloys having a density of 2.65 g/cm³ and disks with an OD of 95 mm or larger. As also explained above, adjustments can be made to the ratio for different substrate alloy densities or Young's modulus values. In other examples, the determination of the preferred ratio may directly take into account parameters of a particular HDD design, such as the spacing budget for head/suspensions, load/unload ramp clearance, and vibration (OD edge deflection), in combination with otherwise routine experimentation. Also, note that for a different substrate material (e.g., glass), a different ratio R may be needed. Likewise, for a different metallic plating compound, other than NiP, a different ratio R may be needed. Based on the teachings and considerations provided herein, one skilled in the art can determine a suitable value for R for a different substrate materials and different plating materials without undue experimentation.

At block 1115, the apparatus determines or computes a satisfactory combined thickness (T) for the NiP layers based on the selected ratio R of the combined thickness of the polished plating layers to the disk thickness, e.g., by computing T=D*R. In one example, where R is 3% and D is 0.5 mm, T is thus determined to be 15 μm (and so the thickness of the two individual polished NiP layers is 7.5 μm). As explained above, issues can arise if the individual NiP layers are less than 5 μm and so, if T is found to be less than 10 μm based on the formula T=D*R, T is instead set to 10 μm (with ½T thus set to 5 μm so each individual polished NiP layer is 4 μm).

At block 1120, the apparatus fabricates (or otherwise obtains) a substrate having a thickness selected so the thickness of the substrate and the two polished NiP plating layers will equal the selected disk thickness D. For the example where the disk is intended to be 0.5 mm and the NiP layers have a combined thickness of 15 μm, the substrate may be 0.485 mm. As explained above, the other layers to be added to the disk (such as the magnetic recording layers) are often very thin (e.g., 110-200 Å) and hence can be ignored when determining the thickness for the substrate. For disks where the additional layers are thicker, their thickness can be taken into account when determining the thickness for the substrate.

At block 1125, the apparatus deposits and polishes the two NiP layers on opposing sides of the substrate, each to a thickness of ½T, so the combined polished NiP layer thickness is T and the ratio R is achieved. Plating may be used to deposit amorphous NiP on an Al—Mg alloy disk. Hence, the deposited layer may be referred to as a plating layer or plated layer. However, NiP can be deposited by sputtering as well. As explained above, in practice it can be difficult to achieve a precise thickness to an NiP layer. However, small variations or differences in the thicknesses of the two polished NiP layers is not a problem so long as the disk meets any specified flatness requirements. (As noted above, significant differences in the thickness of the two layers can result in a disk that is not sufficiently flat.) As such, ½T should be viewed as a target thickness for each of the two polished layers, with T being the target combined thickness for the two polished layers.

At block 1130, the apparatus deposits the magnetic recording layers and other layers/coatings onto the polished NiP-substrate-NiP structure to obtain the final disk. Although not shown in FIG. 11, the disk may then be stacked as shown in FIG. 9 for use in a multi-platter HDD, such as a 11D one-inch HDD.

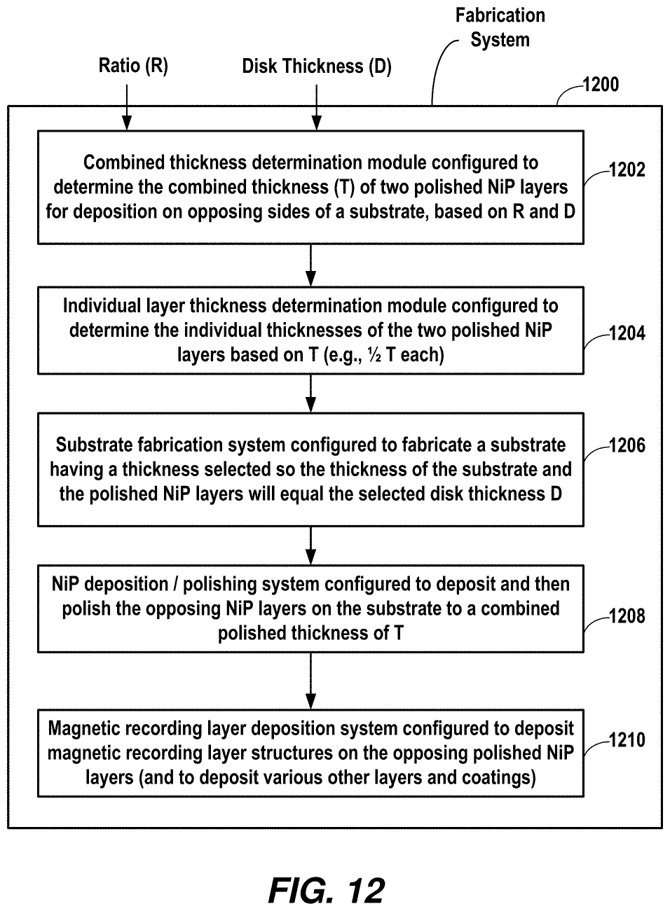

FIG. 12 illustrates an exemplary fabrication apparatus or system 1200 that may be used to fabricate any of the disks shown in the other figures and described herein. The fabrication system 1200 includes a combined thickness determination module (or controller) 1202 configured to determine the combined thickness (T) of two polished NiP layers for deposition on opposing sides of a substrate, based on a ratio (R) and a disk thickness (D), which may be input into the system by operators or technicians. The ratio is representative of a desired ratio of combined polished NiP thickness T to disk thickness D and may be, for example, 3%. The disk thickness is the thickness of the disk to be fabricated, e.g., 0.5 mm or 0.4 mm. The output of the combined thickness determination module 1202 may be, for example, a value T of 14 μm for a 0.5 mm disk or 12 μm fora 0.4 mm disk.

The fabrication system 1200 also includes an individual layer thickness determination module or controller 1204 configured to determine the individual thicknesses of the two polished NiP layers based on T (e.g., ½ T each). Typically, the target thicknesses of the two opposing NiP layers will be the same and so the output is simply ½ T, e.g., 7 μm per NiP layer for a 0.5 mm disk or 6 μm per NiP layer for a 0.4 μm disk.

The fabrication system 1200 further includes a substrate fabrication system 1206 configured to fabricate a substrate having a thickness selected so the thickness of the substrate and the polished NiP layers will equal the selected disk thickness D. For an example where the disk is intended to be D=0.5 mm and the polished NiP layers have a combined thickness T=15 μm, the substrate may be fabricated to a thickness of 0.485 mm.

The fabrication system 1200 further includes an NiP deposition and polishing system 1208 configured to deposit and then polish the opposing NiP layers on the substrate to a combined thickness of T. Note that separate systems may be used for deposition and polishing. That is, one system or apparatus may be used to deposit the NiP layers on opposing sides of the substrate and a different system or apparatus may be used to then polish the NiP layers. Still further, as explained above, NiP layers may be deposited, for example, using a plating process or a sputtering process. A magnetic recording layer deposition system 1210 configured to deposit magnetic recording layer structures on the opposing polished NiP plating layers (and to deposit various other layers and coatings, as may be appropriate).

In some aspects, fabrication system 1200 provides an apparatus for fabricating a disk for use in a magnetic recording apparatus. The combined thickness determination module (or controller) 1202 provides a means for determining a combined thickness for first and second plating layers, wherein the combined thickness is determined based on a predetermined ratio of the combined thickness of the plating layers to a selected disk thickness. The individual layer thickness determination module or controller 1204 provides a means for determining a first plating layer thickness and a second plating layer thickness based on the combined thickness. The substrate fabrication system 1206 provides a means for providing a substrate having a thickness selected so the thickness of the substrate and the first and second plating layers will equal the selected disk thickness. The NiP deposition system 1208 provides a means for depositing the first plating layer with the first plating layer thickness on a first side of the substrate and a means for depositing the second plating layer with the second plating layer thickness on a second, opposing side of the substrate. The magnetic recording layer deposition system 1210 provides a means for depositing a magnetic recording layer on at least one of the plating layers.

### Additional Examples and Embodiments

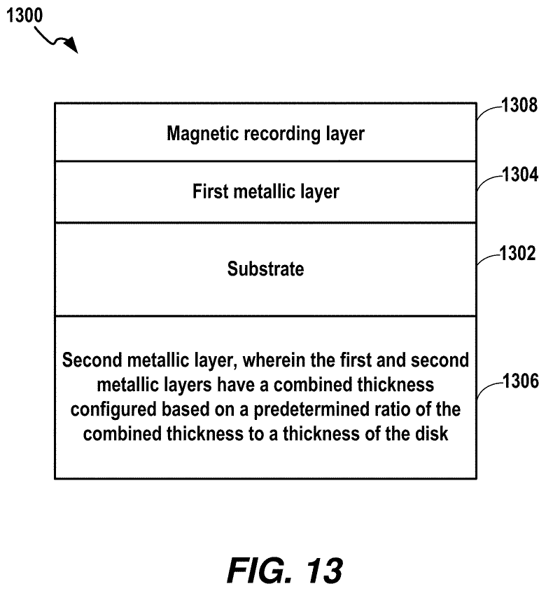

FIG. 13 illustrates an exemplary magnetic recording disk 1300. The disk 1300 includes a substrate 1302 (e.g., a Al—Mg alloy substrate). First and second metallic layers 1304 and 1306 are on opposing sides of the substrate 1302 (e.g., NiP layers). The first and second metallic layers 1304 and 1306 have a combined thickness configured based on a predetermined ratio of the combined thickness to a thickness of the disk. A magnetic recording layer 1308 is on at least the first metallic layer (with the first metallic layer interposed between the magnetic recording layer and the substate). As already explained, another magnetic recording layer may also be provided on the second metallic layer (with the second metallic layer interposed between the magnetic recording layer and the substate). In some examples, additional layers or coatings may be provided, including layers between the metallic layers and the magnetic recording layer(s). Further details of exemplary disks are provided above.

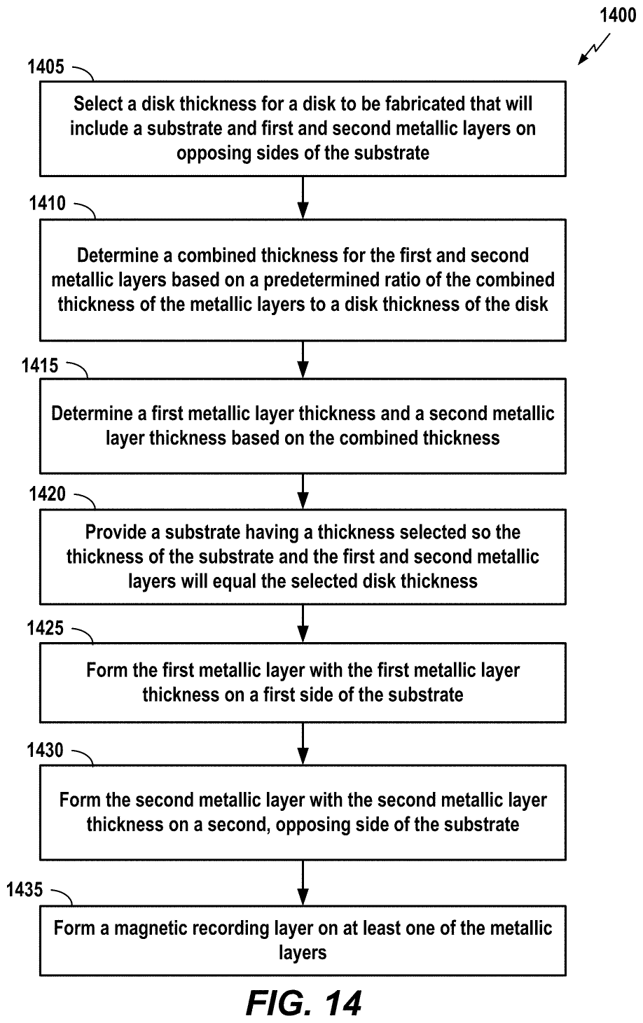

FIG. 14 illustrates an exemplary method 1400 for fabricating a magnetic recording disk including a substrate and first and second metallic layers on opposing sides of the substrate. The method 1400 includes, in block 1405, selecting a disk thickness (e.g., 0.5 mm) for a disk to be fabricated that will include a substrate (e.g., an Al—Mg substrate) and first and second metallic layers (e.g., NiP layers) on opposing sides of the substrate. The method also includes, in block 1410, determining a combined thickness for the first and second metallic layers based on a predetermined ratio (e.g., 3%) of the combined thickness of the metallic layers to a disk thickness of the disk. The method also includes, in block 1415, determining a first metallic layer thickness (e.g., 7.5 μm) and a second metallic layer thickness (e.g., 7.5 μm) based on the combined thickness (e.g., by dividing a combined thickness of 15 μm in half). The method also includes, in block 1420, providing a substrate having a thickness selected so the thickness of the substrate and the first and second metallic layers will equal the selected disk thickness. For example, a 0.5 mm substrate may be polished down to 0.485 mm to accommodate two 7.5 μm NiP layers. The method also includes, in block 1425, forming (depositing) the first metallic layer with the first metallic layer thickness on a first side of the substrate. The method also includes, in block 1430, forming (depositing) the second metallic layer with the second metallic layer thickness on a second, opposing side of the substrate. The method also includes, in block 1435, forming (depositing) a magnetic recording layer on at least one of the metallic layers (and typically on both of the metallic layers). Additional layers or coatings may be provided as well.

### Additional Aspects and Considerations

It shall be appreciated by those skilled in the art in view of the present disclosure that although various exemplary fabrication methods are discussed herein with reference to magnetic recording disks, the methods, with or without some modifications, may be used for fabricating other types of recording disks, for example, optical recording disks such as a compact disc (CD) and a digital-versatile-disk (DVD), or magneto-optical recording disks, or ferroelectric data storage devices.

Various components described in this specification may be described as “including” or made of certain materials or compositions of materials. In one aspect, this can mean that the component consists of the particular material(s). In another aspect, this can mean that the component comprises the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. The term “about ‘value X’”, or “approximately value X”, as used in the disclosure shall mean within 10 percent of the ‘value X’. For example, a value of about 1 or approximately 1, would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range.

What is claimed is:

1. A method for fabricating a magnetic recording disk including a substrate and first and second metallic layers on opposing sides of the substrate, the method comprising:
determining a combined thickness for the first and second metallic layers based on a predetermined ratio of the combined thickness of the metallic layers to a disk thickness of the disk;
determining a first metallic layer thickness and a second metallic layer thickness based on the combined thickness;
providing a substrate having a thickness selected so a thickness of the substrate and the first and second metallic layers will equal the disk thickness;
forming the first metallic layer with the first metallic layer thickness on a first side of the substrate;
forming the second metallic layer with the second metallic layer thickness on a second, opposing side of the substrate; and
forming a magnetic recording layer on at least one of the metallic layers.

2. The method of claim 1, wherein the first and second metallic layers comprise polished metallic layers and wherein the predetermined ratio is a ratio of the combined thickness of the polished metallic layers to the disk thickness.

3. The method of claim 1, wherein the predetermined ratio is between 2% and 4%.

4. The method of claim 1, wherein the predetermined ratio is about 3%.

5. The method of claim 1, wherein determining the first metallic layer thickness and the second metallic layer thickness comprises setting each of the first and second metallic layer thicknesses to one half of the combined thickness.

6. The method of claim 1, wherein the substrate comprises aluminum-magnesium (Al—Mg) with a density between 2.63 and 2.80 grams/centimeter³ (g/cm³).

7. The method of claim 1, wherein the substrate has a Young's modulus of about 68 gigapascals (GPa) and the first and second metallic layers each have a Young's modulus of about 200 GPa.

8. The method of claim 1, wherein the first and second metallic layers comprise nickel-phosphorous (NiP).

9. The method of claim 1, wherein the disk is circular with a diameter of at least 95 millimeters (mm) and the disk thickness is no greater than 0.65 millimeters (mm).

10. The method of claim 1, wherein the disk is circular with a diameter of about 95 millimeters (mm) and the disk thickness is about 0.5 millimeters (mm), and wherein the combined thickness of the first and second metallic layers is 14 microns (μm)±2 μm.

11. The method of claim 1, wherein determining the first metallic layer thickness and the second metallic layer thickness based on the combined thickness further comprises:
determining whether the combined thickness is less than 10 microns (μm); and
in response to a determination that the combined thickness is less than 10 μm, setting both the first metallic layer thickness and the second metallic layer thickness to 4 μm.

12. A magnetic recording disk, comprising:
a substrate;
first and second metallic layers on opposing sides of the substrate, the first and second metallic layers having a combined thickness configured based on a predetermined ratio of the combined thickness to a disk thickness of the disk; and
a magnetic recording layer on at least the first metallic layer.

13. The disk of claim 12, wherein the first and second metallic layers comprise polished metallic layers and wherein the predetermined ratio is a ratio of the combined thickness of the polished metallic layers to the disk thickness.

14. The disk of claim 12, wherein the predetermined ratio is between 2% and 4%.

15. The disk of claim 12, wherein the predetermined ratio is about 3%.

16. The disk of claim 12, wherein a first metallic layer thickness is one half of the combined thickness and wherein a second metallic layer thickness is one half of the combined thickness.

17. The disk of claim 12, wherein the substrate comprises aluminum-magnesium (Al—Mg) with a density between 2.63 and 2.80 grams/centimeter³ (g/cm³).

18. The disk of claim 12, wherein the substrate has a Young's modulus of about 68 gigapascals (GPa) and the first and second metallic layers each have a Young's modulus of about 200 GPa.

19. The disk of claim 12, wherein the first and second metallic layers comprise nickel-phosphorous (NiP).

20. The disk of claim 12, wherein the disk is circular with a diameter of at least 95 millimeters (mm) and the disk thickness is no greater than 0.65 millimeters (mm).

21. The disk of claim 12, wherein the disk is circular with a diameter of about 95 millimeters (mm) and the disk thickness is about 0.5 millimeters (mm), and wherein the combined thickness of the first and second metallic layers is 14 microns (m)±2 μm.

22. A data storage device comprising:
a plurality of the disks of claim 12 disposed in a stacked configuration,
wherein at least one spacer is disposed between each adjacent pair of the disks of the plurality of stacked disks, and
wherein the plurality of the disks is clamped together by a clamping mechanism.

23. An apparatus for fabricating a disk for use in a magnetic recording apparatus, the apparatus comprising:
means for determining a combined thickness for first and second metallic layers, wherein the combined thickness is determined based on a predetermined ratio of the combined thickness of the metallic layers to a disk thickness;
means for determining a first metallic layer thickness and a second metallic layer thickness based on the combined thickness;
means for providing a substrate having a thickness selected so the thickness of the substrate and the first and second metallic layers will equal the disk thickness;
means for depositing the first metallic layer with the first metallic layer thickness on a first side of the substrate;
means for depositing the second metallic layer with the second metallic layer thickness on a second, opposing side of the substrate; and
means for depositing a magnetic recording layer on at least one of the metallic layers.
